(19) United States
(12) Patent Application Publication
(10) Pub. No.: US 2012/0024076 A1
(43) Pub. Date: Feb. 2, 2012

(54) MECHANICAL MOVEMENTS ADJUSTED BY ELECTROMAGNETIC PROBE

(76) Inventors: José Buendia, Bourgoin Jallieu (FR); Claude Annie Perrichon, L' Isle d' Abeau (FR); Pierre Piccaluga, Prangins (CH); François Giry, Challes les Eaux (FR)

(21) Appl. No.: 13/255,685

(22) PCT Filed: Aug. 14, 2009
(86) PCT No.: PCT/FR2009/001006

§ 371 Date: Sep. 9, 2011

(30) Foreign Application Priority Data
Mar. 12, 2009 (FR) PCT/FR2009/000259
May 25, 2009 (FR) PCT/FR2009/000599
Jul. 28, 2009 (FR) PCT/FR2009/000936

(51) Int. Cl. G01L 1/00

(52) U.S. Cl. 73/763

(57) ABSTRACT

Mechanical stresses of a mobile control gear are managed using piezoelectric probes adjacent the mobile control gear. The piezoelectric probes are hypersensitive to electromagnetic fields and are configured to identify electronic information corresponding to mechanical stresses in the mobile control gear based on receiving a flow of electrons in an ambient space, and to transmit the electronic information in reverse phase to the mobile control gear to reduce vibrations of the mobile control gear.

### RELATED APPLICATIONS

This application filing is an extension of the works carried out over the last three years for the use of chemistry and elastic deformation effects of materials that generate electromagnetic fields in ambient space. The electromagnetic fields are fluctuations that move in matter or in air. The fluctuations are stabilized by an electronic information loop in the matter. Priority is claimed in PCT publication PCT/FR2009/000259 titled “Electronic Organization for Dynamic, Chemical and Mechanical Performances.” Priority is also claimed to PCT publication PCT/FR2009/000936 titled “The Complex Balancing of Rotating Mechanical Parts” and to PCT publication PCT/FR2009/000599 titled “Cleaning Electromagnetic Pollution.” The priority documents provide generality of the functions of an electronic component called an eCRT probe, which is based on three simultaneous activities nested therein, and having novel applications.

### FIELD OF THE INVENTION

The medium of the application is a relevant but nonexhaustive exemplary embodiment, which perfectly shows the circumstances of usefulness of the present application, which is characterized by a regulation of the mechanical effects of several mechanical members which are independent by their different functions but constantly interacting. The electronic information sensitivity of the matter revealed makes it possible to provide the corrections via the eCRT probes of the present application.

The effects of the mechanical parts are brought into line by the electromagnetic field information emitted in the ambient space that the eCRT probes will instantaneously regulate. This feedback will regulate the mechanical effects to bring them all into line by the electron information which moves around in the air, and will inform and give consistency to the activities of the mechanical parts so that they transmit the mechanical forces in the same direction. This releases the internal forces to which the mechanical parts are subjected.

This application shows the effects of the EMC (electromagnetic compatibility) emanations picked up and controlled, in the ambient space, which is an innovation over the mechanical regulation method. In fact, nanotechnology is based on the migration of the electron fluxes which is able to provide information. This may be difficult for a mechanic to accept, but this application demonstrates a number of known problems that have been addressed but whose effects have never been eliminated.

### BACKGROUND OF THE INVENTION

Electromagnetic compatibility exposes magnetic fields diffused in space, automobiles, aviation and boats, and also industrial machines. Machines generate electromagnetic emanations because of the movement, displacement and torsional activities of their mechanical parts.

### DETAILED DESCRIPTION OF THE PREFERRED EMBODIMENTS

We can demonstrate disappearance of the electromagnetic pollutions in the passenger compartment in a car after processing on the wheels and engine. In this demonstration, after processing, a portable telephone is placed in the passenger compartment on the floor toward the closed doors while the vehicle is rolling. Connection with a Bluetooth earpiece is linked to the telephone on the floor of the vehicle. A significant volume swell of the engine is heard, which varies with the speed of the wheels and of the engine. After processing, there is no longer any stray volume swell, and the communications is no longer affected by electromagnetic pollution which is picked up by the telephone and the earpiece link.

We obtain a considerable lowering of the electromagnetic pollution known in the industrial world, but never stopped at its root, but at its origin. This is one of the effects corrected by putting in place the present method that we highlight by the means used and the placement of the probes which allow for essential mechanical behavior corrections that we seek to obtain.

The object of the present application is the servo-regulation of the mechanical forces and of the mechanical vibrations generated by contradictory forces canceling one another partially in opposition, or even only with a phase difference of mechanical actions. The parts that have different functions but interact together give degraded mechanical performance levels and other disagreeable collateral effects to be eliminated, such as vibrations, loss of road grip, electromagnetic pollutions and unnecessary wear of the parts, all of which are subject to the mechanical stresses that we can eliminate.

A simple day-to-day example illustrates our device and the forces involved, but which is not exhaustive in its embodiment or application. In FIG. 2, a wheel with a tire 5 is rolling on a road with an uneven and irregular profile 4. The wheel supports the weight 6 to be transported. The motor function is the force 2 which is exerted on the wheel axle. This obtains the reaction 3 of the force advancing the tire on the road. The damper or shock 1 is subject to all the reactions of the bounces of the tire which acts as a balloon on the road, held by the weight to be transported plus the torque of the power to be transmitted by the elasticity of the tire which transfers the force from the wheel axle to the roadway. That is the motor function force of the weight 6 to be transported.

In brief, the wheel, by its axle and the tire while rolling, transfers all the weight and power forces and accepts the deformations of the ground. There, the tire must also be balanced over its own distribution of the weights, which precludes the dynamic reality as a real function which is much more complex than simple balancing. This does not take account of the deformation of the tire and of its internal tensions between the tread, and the sidewalls which transpose the powers, the braking forces, the deformations of the road and the weight to be carried.

The driving stability translational forces for the weights on acceleration and on braking are very high tensions and pressures, which sometimes oppose and are supported by the mechanical structures of the parts of the wheels, such as its axle and the structure of the tread rubbers used. These tensions and these pressures generate, according to the elastic deformations of the materials, magnetic fluxes in the ambient space, intense movements of magnetic charges, like any friction of the tread rubbers on the roadway.

All these in-phase or partially contradictory mechanical forces are identified by fluctuations of electron charges emitted by each mechanical part subject to variable stresses. The electromagnetic fields identified by the electromagnetic probes represent the eCRT components. The electromagnetic field probes represented by the so-called “eCRT” technology sense information in the ambient space of the mechanical stresses undergone by the electron flux information emitted in these conditions, and return them in reverse phases. This magnetic field self-regulation process leads to a regulation of the mechanical behaviors, which are directly linked thereto. The eCRT absorbs the electron flux information and returns them in reverse phase, which tends to immobilize them at the source, and to make uniform all the movements of the mechanical parts brought into play on a wheel, a front or rear vehicle running gear, by processing the information fluxes of each of the mechanical parts involved.

The result of this is rolling comfort and softness and greater available power which are liberated from the mechanical stresses which previously fought one another. The application uses the electronic component which proceeds with the absorption of the magnetic charges by the metallic matter included in the piezoelectric component which transforms them into electric current and eliminates them in the form of mechanical vibrations.

This is one of the eCRT characteristics that we know but it is organized differently in the specifics of the present application. There is a regulation of information by magnetic charges emitted in the ambient space by moving mechanical parts which will be instantaneously self-servo-controlled electronically and mechanically by the electromagnetic charge probes.

The appliance disclosed herein cleans the magnetic charge which is sensed in the space of activity of the wheels by the eCRT probes consisting of the metallic charges contained, immersed in the piezo-electric matter consisting of different quartzes and silica, bound in a polymer, for example. The introduction of copper, gold, iron or metal powder in the piezo allows for the conversion of the magnetic charge into an electric charge which is immediately transformed in reverse phase and retransmitted, and which allows for an instantaneous self-servo-control of the mechanical reactions. By way of experiment, we have worked with metal or aluminum powder and, depending on the concentration, we record more or less intense piezoelectric activity depending on the frequency of the magnetic charges generated by the mechanical parts.

Powder with a certain grain size, concentration in the mixture of the piezo paste, makes it possible to receive much more current, in frequencies and in amplitudes, without being specially tuned. This is the case of resolution of vibrations, of complex dynamic balancing, of the moving parts, of the wheels, of the dampers and of the tires. Powder makes it possible to have an overall holistic effect, sensitive to all the magnetic charges working around the electronic component, and in the space of the activities of the wheels, and of the running gears. The technologies of the eCRT probes make reference to the energies of the weak bonds and to the dipoles of Van der Waals, of the laws of Laplace, Hertz, Lorentz, Gauss, Maxwell and Faraday.

Applications of the eCRT (electron converter real time) reveal a product with multiple applications which are managed by the eCRT component for which the three general functions are indicated. This balance is to naturally clean the excesses of magnetic charges appearing in the space, around and in the parts activating and holding the wheels.

Nanotechnology comes to the aid of the mechanical tension effects through a hypersensitivity to the electrons, electronic information which inform on the mechanical stresses undergone, which makes it possible to sense the migration of the electrons as electric current on which the piezo feeds. The magnetic fields are sensed, and are converted and returned as information in reverse phase to obtain a self-regulation of the optimized mechanical stresses. These functions are all natural, but, when combined together, they create new functions specific to this method.

This vision of nanotechnology makes it possible to resolve, on a grand scale, difficult solutions with this simplicity of operation. Resolutions of which give us comprehensive results through new hyperfine and sensitive approaches of diagnostics, of identifications and of available energy management. The complex balancing within the matter, such as the deformations of the suspensions in collaboration with the tread rubber of the tires and of the weights of the car chassis have become possible, through three functions and three actions of the piezoelectricity with added metallic powder:
1. Magnetic field sensed by metallic powder;
2. Magnetic field transformed into electric current; and
3. Electric current transformed by the piezoelectric into reverse phase and into mechanical vibration tending to cancel out the origin of the effects; Laplace law which opposes the displacement imposed (counter-electromotive force that we use in this example).

These three phases characterize the eCRT electronic component. Its functions are instantaneous, simultaneous, natural, and of a sensitivity to defy any industrialized system belonging to the pure characteristics of the matter of the solid state matrix eCRT.

This electronic component is a new generation through its high resolution in sensing the electromagnetic information. It allows for a possible processing of the generations of inherently mechanical, and inherently electromagnetic self-induced currents. Knowing that a wheel, by rolling according to its aluminum or metal rim and according to its radius, is considered as a Barlow wheel or a Telma. These electronic, vibration, and self-servo-control management functions are possible because they are all based on the electronic edifice which is strained, shaken by the mechanical stresses, and all the structures are affected, including chemical, mechanical, fluids and gases.

In a wheel, axle, and tire, all these electromagnetic applications are involved. All the technical domains in dynamic phase, by virtue of the unique edifice of the matter made up of electrons involved in the functions of the mechanics, the gases, and the ambient air are involved. These functions are the use of the servo-control of the mechanical vibratory and electronic undulatory performance levels and concern the use of the mechanics, of solids, of fluids and of gases represented by the ambient air in this particular case of self-regulation of mechanical deformations.

The active players, like the mechanics, are just as involved as the information transported or transformed in the air space in which the “eCRT” probe binds the magnetic compatibilities, with air being transporters of electron charges giving the information. All industrialization is affected by the flows of the electrons agitated by the actions of the mechanical members that make up the running gears, for example, under multiple tensions, or stretching, or motional stresses.

In this eCRT self-servo-control, one of the functions is to fight against the build-up of electrons which are generated by all the mechanical stresses. The eCRT tendency is to stop this electromagnetic fluctuation resulting from the forces in in-phase and out-of-phase actions, by stabilizing the fluctuating electronic state. The eCRT probe thus stabilizes the movement states made fluid, constants of the matter, and the dynamic conditions become harmonious without vibrations.

The build-up of a certain variable electrical potential dependent on the driving, the weight of the vehicle, and the road is discharged, absorbed by the eCRT probe, and another portion is returned in reverse phase. This tends toward a stabilized potential, which constitutes the greater part of the self-servo-control of the balancing of the forces by the probes of the eCRT appliances. The balancing potential is, in this complex application, instantaneous, for all the interacting forces. This stabilization finally gives an excellent solution to the various agitations stopped and regulated.

The eCRT probes, which are highly reactive between themselves and the environment containing the mechanical parts, block by self-servo-control the natural activities of the electrons as soon as they occur. This definitively stops any vibratory movement, and of associated electrons fleeing from the movements based on Lenz and Laplace laws. This keeps the structures of the wheels stable and renders all the mechanical parts active with in-phase mechanical forces.

This effect of overall stabilization of the forces gives new unknown sensations that the tire manufacturers were not capable of producing, but that they hoped for. In fact, it took a technology unifying the mechanical disturbances by the adoption of nanotechnology which is common to all the edifices of the rigid, elastic and gaseous matters of the tires to unify the distributions of the mechanical forces and optimize the efficiencies. This natural reactivity of absorbing the electromagnetic charges and also this action of eCRT probe counter-reactivity to each of the forces generated acting together on the wheels can be exerted only if there is a reference memory, of a known state, which serves as reference for the stable condition.

Without memory, there would not be any reactivity exactly proportional in reverse phase to the intensities and amplitudes of the imposed mechanical forces, which ultimately, for the same reasons, are automatically stabilized. In fact, the initial aim of the electrons are to oppose the movements of the mechanical stresses, which, through the eCRT, becomes effective and is a mechanical self-management of the dispelled damaging effects of all the aggressions of the mechanical stresses. The result is an absence of noise when rolling, in absolute comfort, which erases all the force and agitation tensions while the vehicle is rolling and the forces are in phase, thus increasing the efficiency.

This first balancing regulation mode, which is resolved with the eCRT, is that of the elastic deformation of the materials in which the migration of the electrons is greatly attenuated, thus making the rolling vehicle stable.

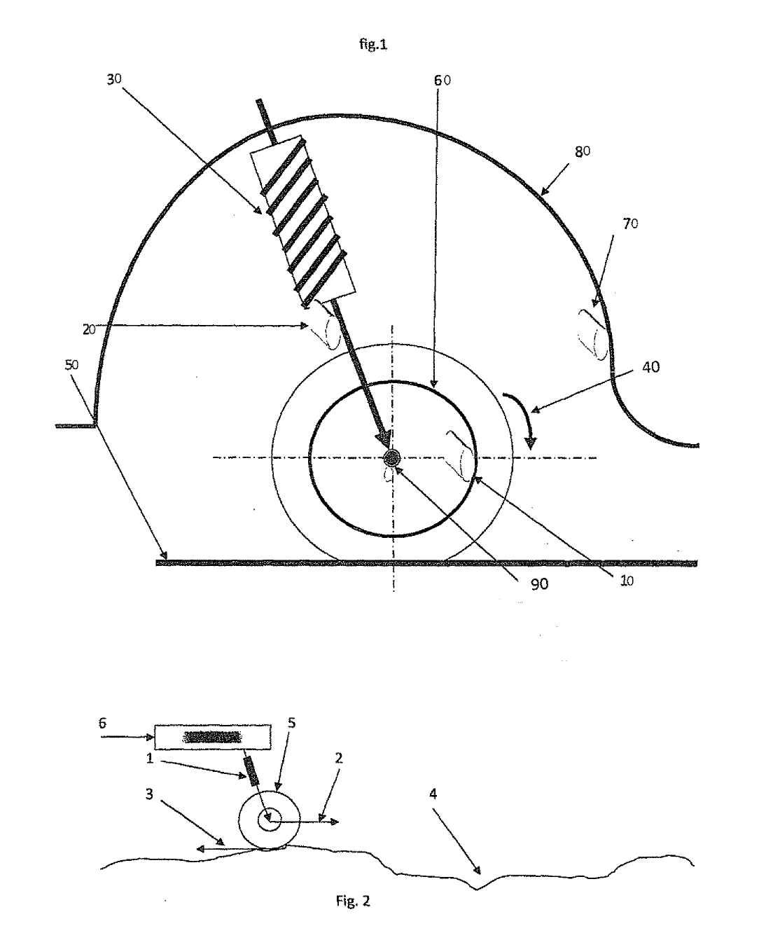

There are two mechanical stresses to address. On the one hand there are the overall forces due to the traction, the braking, the weight of the vehicle and the profile of the road. On the other hand there is the predictable periodic partial deformation of the tire on the road. The eCRT probes measure all of these movement differentials. For this, FIG. 1 illustrates a number of eCRT probes. A first probe 10 is installed on the wheel inside the rim 60, for example, which informs on the rotational movement 40 of the wheel and on the deformation of the tire.

A second probe 20 is placed on the arm, i.e., the strut 30 which holds the axle of the wheel, and is subject to the profile absorbed by the tire controlled by the surface of the roadway 50 and its asphalt grain, with an essentially vertical displacement.

A third probe 70 is placed on the body 80 in front of the tire, and gives the movement of the body shell of the vehicle or of the chassis. The three probes, which are glued, for example, give information concerning all the mechanical movements and search for the most uniform solution, which is the regulation of the self-servo-control of the present method, via the information collected.

A fourth probe is mounted on the axle 90 of the wheel and gives information on the motor function or on the direction of the vehicle, which renders all the mechanical functions uniform. With the “eCRT probe” method all the information concerning the mechanical functions are known and instantaneously optimized, by the electronic information, which is something which no computer can do in such a short time.

The method instantaneously releases the stresses that were previously supported by certain parts for no return. This method stands up to all the known servo-controls, with this “solid matrix” electronic component that implements the three functions instantaneously. It should be noted that there are no electrical link wires and that all the information connections pass through the ambient air via the electronic information sensed directly by the eCRT probes.

The integration of this nanotechnology technology allows for and provides industry with a huge subtlety, self-informing and self-regulating, through the sensitivity of the electronic matter which effortlessly contributes to and is harmonized with our constraints and our mechanical needs. This short circuits an erroneous attitude for a compulsory external monitoring. It is said that servo-controls are a delayed compensation for an event already executed in the past. That is, a delay time in the execution, which is a counter-performance factor, in a perfectly Cartesian analysis among mechanical engineers.

A bridge is crossed with nanotechnology activities, which is a technology providing ultra-fast natural information on the behavior of the electrons and of the mechanics. Mechanical engineers believed that they were totally insulated from and independent of all electronic reactivities.

However, sensitivity to pollution has revealed certain quite natural aggregate activities involved in life. Sound has distorted the drifts of the mechanical effects which emanate as pollution from electromagnetic charges betrayed by the sound, and by the harmonic alterations undergone.

In fact, the magnetic fields represent very important regulation electronic information. Ultimately, Einstein had encompassed and eclipsed, with a simple formula, the concepts of Newton whose consequences we did not know how to use. De Broglie had revealed the fluctuation of the electrons to be evaded and revert from the corpuscular form to the undulatory form represented by the magnetic fields. By this method, we show the use of these effects which had not been correctly interpreted and used.

With this application we demonstrate, through quantifiable experience, the behaviors of the mechanical parts, the absence of electromagnetic radiation and the releasing of the forces. The importance of the electronic states passing in undulatory and corpuscular phase, makes obvious the relationship between matter and air, information and possible corrections by the electrons common to both structures and in fact to all the structures in which the charges of the magnetic fields travel without any resistance.

Matter cannot be destroyed, only transformed. This saying reinforces the understanding of the present method, and confirms the explanation of a natural reactivity of the monitoring of the information from nature already available from which we use the intelligence, due to its primeval memory. It is obvious that driving in rain is excellent and that the braking and safety are greatly increased. The fatigue threshold is pushed back a long way.

Different applications falling under complex problems on the mechanical or hydraulic members on industrial machines or engines can, with this method, find reliability solutions and more stable operation. This method is a self-stabilizer of complex stresses, of kinetic mechanic orders and of the management of gases or liquids in the industrial world.

This novel self-regulation technique revealed by nanotechnology and its probes is a great step forward in known problems, as yet not genuinely resolved, or seen only in a static manner. A single factor has been taken into account, masking the reality of the matter to react and to allow the electromagnetic information to pass in total transparency. The eCRT probe appliance weighs from approximately 20 grams to 70 grams. The values are lower for a motorbike, a small car or a bicycle.

However, a large motorbike seems very light and very easy to drive and to steer, with disconcerting abilities. Applications on helicopter blades can be resolved at sensitive points, or be diagnosed by measuring the electrons roaming around as a result of strong mechanical stresses agitating them, by specific elastic deformations. All the mechanics that are of a “inertial mass” nature on our planet are affected, and surely elsewhere with different gravitational coefficients.

All land, submarine and aeronautical vehicles are affected, the entire conversion and food industry, or energy production industry, or heat or electric engines, to give a few nonlimiting examples of applications. Nanotechnology opens the doors of wireless communication, in which the self-servo-control functions require no wires, and allow for dialog concerning the electronic information of the mechanical parts, via the information from the magnetic charges in the air and the ambient space. It has been found that it is the radio self-regulation which actively links the eCRT probes to the mechanical parts.

Consequently, that which has sometimes been called electromagnetic pollution, as yet unresolved, is a reactivity of the matter to be expressed and that we now use in an ordered manner. The premises concerning such a behavior of the matter had been passed onto us without us being able to access the technical sequencing of its applications.

The present application innovates on the fact of the knowledge of the property of the matter systematically implemented by the eCRT probe, by the understanding of the emissions and receptions of the electrons in the magnetic fields assigned to such a problem emanating from the stressed mechanical parts. These are perfectly identified without interference from their frequencies and amplitudes and kinds of electrons, which can be managed by the eCRT probes, by virtue of the sound applications which have allowed us to identify the sound and electromagnetic signatures specific to each component.

The sound signatures were not sufficient. We had to find the triggers for these functions which were as yet without applications, but they had a reason to exist, that we now show in a dynamic behavior chain. Nanotechnology opens up a new relationship of information and of electronic management without electrical wire, unifying the different sciences of the mechanics of solids, liquids, gases, and of electricity in action, in dynamic phase, through the natural “self-regulation radio” eCRT radio management.

It can be stated that the internal vagary of each “own reactivity” part is erased in favor of a single “global reactivity” function unifying the unique quality of the function required at each instant making the mobile control gear of the machine very powerful, in this case, the front and rear running gear.

The eCRT probes unifying and concentrating the forces in a single action polarity give each part the correct behavior information, and they remain independent, assuming their function as best they can. The efficiencies provide a reduction of half a liter of fuel for a vehicle consuming approximately 10 liters every hundred kilometers. A noise reduction reaches approximately 2 decibels.

1-6. (canceled)

7. A method for dynamically managing mechanical stresses of a mobile control gear comprising_{:}
positioning at least one piezoelectric probe adjacent the mobile control gear, the at least one piezoelectric probe configured to
identify electronic information corresponding to mechanical stresses in the mobile control gear based on receiving the flows of electrons in an adjacent space, and
transmit the electronic information in reverse phase to the mobile control gear to reduce vibrations of the mobile control gear.

8. The method according to claim 7, wherein the at least one piezoelectric probe is placed directly on the mobile control gear.

9. The method according to claim 8, wherein glue is used to secure the at least one piezoelectric probe directly on the mobile control gear.

10. The method according to claim 7, wherein the at least one piezoelectric probe is based on nanotechnology.

11. The method according to claim 7, wherein the at least one piezoelectric probe weighs within a range of 20 to 70 grams.

12. The method according to claim 7, wherein the at least one piezoelectric probe detects and corrects at least one of asymmetric and parasitic movement of electrons in the mobile control gear.

13. The method according to claim 7, wherein the at least one piezoelectric probe comprises at least one of quartz and silica, and further comprises a metallic powder.

14. The method according to claim 13, wherein the metallic powder comprises at least one of copper, gold and iron.

15. The method according to claim 7, wherein the mobile control gear comprises a wheel, an axle for the wheel, and a strut for the wheel; and wherein the at least one piezoelectric probe comprises a piezoelectric probe for the wheel, a piezoelectric probe for the axle and a piezoelectric probe for the strut.

16. The method according to claim 7, wherein the mobile control gear is part of at least one of a land vehicle, a water vehicle and an aeronautical vehicle.

17. An appliance for dynamically managing mechanical stresses of a mobile control gear, the appliance comprising:
at least one piezoelectric probe adjacent the mobile control gear, and configured to
identify electronic information corresponding to mechanical stresses in the mobile control gear based on receiving flows of electrons in an adjacent space, and
transmit the electronic information in reverse phase to the mobile control gear to reduce vibrations of the mobile control gear.

18. The appliance according to claim 17, wherein said at least one piezoelectric probe is placed directly on the mobile control gear.

19. The appliance according to claim 18, wherein glue is used to secure said at least one piezoelectric probe directly on the mobile control gear.

20. The appliance according to claim 17, wherein said at least one piezoelectric probe is based on nanotechnology.

21. The appliance according to claim 17, wherein said at least one piezoelectric probe weighs within a range of 20 to 70 grams.

22. The appliance according to claim 17, wherein said at least one piezoelectric probe detects and corrects at least one of asymmetric and parasitic movement of electrons in the mobile control gear.

23. The appliance according to claim 17, wherein said at least one piezoelectric probe comprises at least one of quartz and silica, and further comprises a metallic powder.

24. The appliance according to claim 23, wherein the metallic powder comprises at least one of copper, gold and iron.

25. The appliance according to claim 17, wherein the mobile control gear comprises a wheel, an axle for the wheel, and a strut for the wheel; and wherein said at least one piezoelectric probe comprises a piezoelectric probe for the wheel, a piezoelectric probe for the axle and a piezoelectric probe for the strut.

26. The appliance according to claim 17, wherein the mobile control gear is part of at least one of a land vehicle, a water vehicle and an aeronautical vehicle.
